(19) United States
(12) Patent Application Publication
(10) Pub. No.: US 2011/0019415 A1
(43) Pub. Date: Jan. 27, 2011

(54) HEAT DISSIPATING MODULE OF LIGHT EMITTING DIODE

(76) Inventor: WEI-TING CHEN, Taoyuan City (TW)

Correspondence Address: WPAT, PC;INTELLECTUAL PROPERTY ATTORNEYS, 7225 BEVERLY ST., ANNANDALE, VA, 22003, US

(21) Appl. No.: 12/628,444

(22) Filed: Dec. 1, 2009

(30) Foreign Application Priority Data
Jul. 24, 2009 (TW) 098213594

(51) Int. Cl. F21S 4/00

(52) U.S. Cl. 362/249.02; 362/294

(57) ABSTRACT

A LED heat dissipating module includes a plurality of flat light emitting diodes, a circuit board having a plurality of perforations, a plurality of thermally-conductive structures, and a thermally-conductive metallic slice disposed on the backside of the circuit board. The thermally-conductive structures are penetrated through the perforations and in contact with the flat light emitting diodes and the thermally-conductive metallic slice. The heat energy generated from the flat light emitting diodes is conducted from the thermally-conductive structures to the thermally-conductive metallic slice, and then exhausted out of the LED heat dissipating module from the thermally-conductive metallic slice.

### FIELD OF THE INVENTION

The present invention relates to a structure of a light emitting diode, and more particularly to a heat dissipating module of a light emitting diode.

### BACKGROUND OF THE INVENTION

In recent years, light emitting diodes (LEDs) are widely used in many fields. For example, LEDs are used as backlight sources of LCD panels, white light sources, light sources of mini projectors, automobile lighting devices, and the like. LEDs have earned positive feedback ratings in the above application fields. Generally, the efficiency of converting electrical energy of an LED into visible light is approximately 20% of the input power; and approximately 80% of the input power is radiated in the form of heat energy and the accumulated in the LED. If the heat energy fails to be quickly exhausted, the illuminating intensity is reduced and the use life of the LED is shortened.

Generally, LEDs are usually classified into two types, i.e. a lamp type LED and a flat type LED. The heat dissipating modules of a lamp type LED and a flat type LED will be illustrated in more details with reference to FIGS. 1A and 1B.

FIG. 1A is a schematic view illustrating a lamp LED heat dissipating module according to the prior art. As shown in FIG. 1A, the lamp LED heat dissipating module 1 comprises a lamp LED 10 and a circuit board 11. The lamp LED 10 has a transparent bullet-shaped lampshade, and is disposed on the circuit board 11. Electric energy is transmitted to the lamp LED 10 through the circuit board 11, and converted into light energy and heat energy. The light energy is used to generate the illuminating light beam. For preventing from an over-heated condition, the heat energy should be exhausted out of the lamp LED 10 and the possibility of damaging the lamp LED 10 is minimized. For example, the circuit board 11 is an aluminum-based MCPCB (metal core printed circuit board). The aluminum-based MCPCB has high thermal conductivity for facilitating exhausting heat energy.

FIG. 1B is a schematic view illustrating a flat LED heat dissipating module according to the prior art. As shown in FIG. 1B, the flat LED heat dissipating module 2 comprises a flat LED 20 and a circuit board 21. The flat LED 20 is directly mounted on the circuit board 21. Since the flat LED 20 is mounted on the circuit board 21 according to a surface mount technology (SMT), the flat LED 20 is also referred as a surface mount device LED (SMD LED). For example, the circuit board 21 is made of epoxy glass fiber sheet (FR4) material. As known, the circuit board 21 made of FR4 has low heat dissipating efficiency. Since the flat LED 20 is in direct contact with the circuit board 21, the heat energy generated by the flat LED 20 could be also transmitted to the circuit board 21.

When the lamp LED heat dissipating module 1 is compared with the flat LED heat dissipating module 2, it is found that the lamp LED heat dissipating module 1 has better thermally-conductive capability. As known, since the process of fabricating the lamp LED heat dissipating module 1 is very complicated, the assembling cost of the lamp LED heat dissipating module 1 is relatively high. In addition, the lamp LED heat dissipating module 1 is readily burnt out if the output power is high. Although the flat LED heat dissipating module 2 has lower assembling cost, the heat dissipating efficiency of the flat LED heat dissipating module 2 is unsatisfactory and the output power thereof is limited.

Therefore, there is a need of providing a LED heat dissipating module having enhanced heat dissipating efficiency and cost-effectiveness.

### SUMMARY OF THE INVENTION

It is an object of the present invention to provide a LED heat dissipating module having enhanced heat dissipating efficiency.

In accordance with an aspect of the present invention, there is provided a LED heat dissipating module. The LED heat dissipating module includes a circuit board, a plurality of light emitting diodes, a plurality of thermally-conductive structures, and a thermally-conductive metallic slice. The circuit board has a plurality of perforations. The light emitting diodes are disposed on a surface of the circuit board and corresponding to respective perforations. The perforations are covered by corresponding light emitting diodes. The thermally-conductive structures are connected with respective light emitting diodes and inserted into corresponding perforations for conducting heat energy that is generated from the light emitting diodes. The thermally-conductive metallic slice has a plurality openings corresponding to the perforations of the circuit board such that the thermally-conductive structures are permitted to be penetrated through corresponding openings. The thermally-conductive metallic slice is disposed on a backside of the circuit board and in contact with the thermally-conductive structures for conducting the heat energy that is generated from the light emitting diodes and removing the heat energy.

In an embodiment, the openings are aligned with the perforations of the circuit board such that the thermally-conductive structures are penetrated through corresponding perforations and corresponding openings.

In an embodiment, the thermally-conductive metallic slice is a tin board or a gold-plated board.

In an embodiment, the LED heat dissipating module further includes a heat sink, which is in contact with the thermally-conductive metallic slice and the thermally-conductive structures for facilitating dissipating the heat energy.

In an embodiment, the heat sink is made of aluminum.

In an embodiment, the circuit board is made of epoxy glass fiber sheet (FR4) material.

In an embodiment, the light emitting diodes are surface mount device LEDs (SMD LEDs) that are mounted on the circuit board according to a surface mount technology (SMT).

In an embodiment, each of the SMD LEDs is a 5050 SMD LED having a dimension of 5 mm×5 mm.

In an embodiment, the thermally-conductive structures are thermal greases or thermal adhesives.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A is a schematic view illustrating a lamp LED heat dissipating module according to the prior art;

FIG. 1B is a schematic view illustrating a flat LED heat dissipating module according to the prior art;

FIG. 2 is a schematic top view illustrating a LED heat dissipating module according to a first embodiment of the present invention;

FIG. 3 is a schematic front view illustrating a LED heat dissipating module according to the first embodiment of the present invention, in which the thermally-conductive structures are not included;

FIG. 4 is a schematic front view illustrating a LED heat dissipating module according to the first embodiment of the present invention, in which the thermally-conductive structures are included; and

FIG. 5 is a schematic front view illustrating a LED heat dissipating module according to a second embodiment of the present invention.

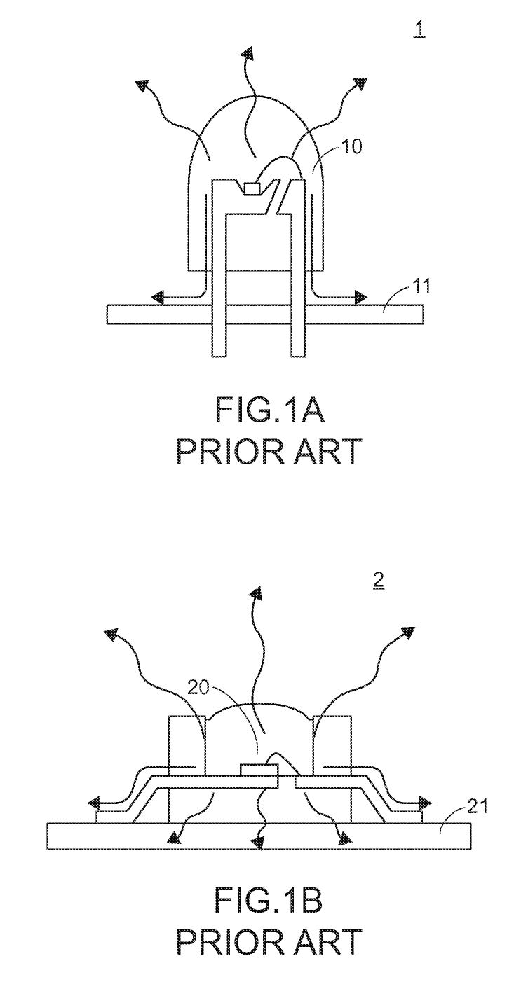

### DETAILED DESCRIPTION OF THE PREFERRED EMBODIMENT

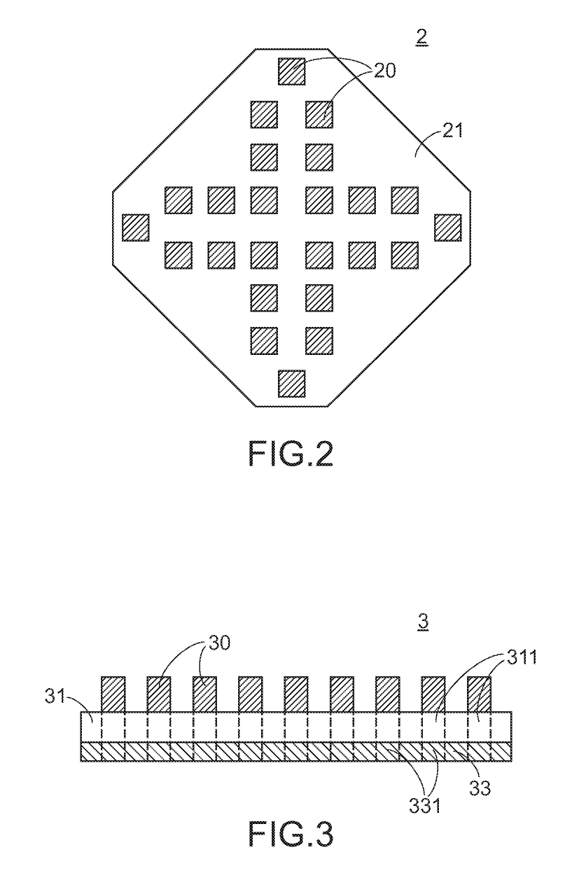

For overcoming the problems encountered from the prior art, the present invention provides a LED heat dissipating module having enhanced heat dissipating efficiency. Please refer to FIGS. 2 and 3. FIG. 2 is a schematic top view illustrating a LED heat dissipating module according to a first embodiment of the present invention. FIG. 3 is a schematic front view illustrating a LED heat dissipating module according to the first embodiment of the present invention, in which the thermally-conductive structures are not shown. The LED heat dissipating module 3 comprises a plurality of LEDs 30, a circuit board 31, a plurality of thermally-conductive structures 32 (not shown), and a thermally-conductive metallic slice 33.

Please refer to FIGS. 2 and 3 again. The circuit board 31 comprises a plurality of perforations 311. The number of perforations 311 is the same as the number of LEDs 30. In this embodiment, the circuit board 31 is made of epoxy glass fiber sheet (FR4) material. In addition, the circuit board 31 has a trace pattern. The operating principle of the trace pattern is known in the art, and is not redundantly described herein. The LEDs 30 are disposed on a surface of the circuit board 31 for generating light beams. The LEDs 30 are aligned with respective perforations 311 and cover respective perforations 311. In this embodiment, the LEDs 30 are flat LEDs. In particular, each of the flat LEDs 30 is a 5050 SMD LED having a dimension of 5 mm×5 mm. The thermally-conductive metallic slice 33 is disposed on the backside of the circuit board 31. The thermally-conductive metallic slice 33 comprises a plurality of openings 331. The openings 331 are aligned with the perforations 311 of the circuit board 31. The thermally-conductive structures 32 are simultaneously penetrated through the perforations 311 and the openings 331. An example of the thermally-conductive metallic slice 33 includes but is not limited to a tin board or a gold-plated board.

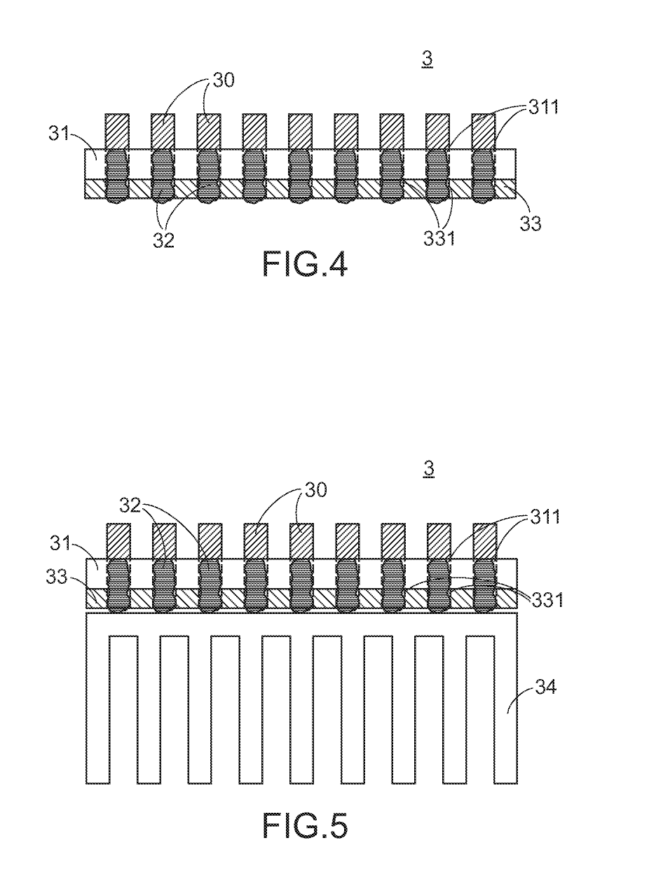

FIG. 4 is a schematic front view illustrating a LED heat dissipating module according to the first embodiment of the present invention, in which the thermally-conductive structures are included. As shown in FIG. 4, the thermally-conductive structures 32 are accommodated within the perforations 311 of the circuit board 31 and penetrated through the openings 331 of the thermally-conductive metallic slice 33, so that the thermally-conductive structures 32 are in contact with the thermally-conductive metallic slice 33. The thermally-conductive structures 32 are used for conducting the heat energy that is generated from the flat LEDs 30. Examples of the thermally-conductive structures 32 include but are not limited to thermal greases or thermal adhesives. The heat energy that is transferred from the thermally-conductive structures 32 are conducted to the thermally-conductive metallic slice 33 and dissipated away.

Please refer to FIG. 4 again. During the flat LEDs 30 emit light beams (not shown), heat energy is also generated by the flat LEDs 30. Since the thermally-conductive structures 32 are penetrated through the perforations 311 and the openings 331 and in direct contact with the flat LEDs 30, a portion of the heat energy generated from the flat LEDs 30 could be transferred to the thermally-conductive metallic slice 33. The heat energy is then exhausted out of the LED heat dissipating module 3 from the thermally-conductive metallic slice 33. On the other hand, since the thermally-conductive structures 32 are penetrated through the openings 331 and exposed to the outside of the thermally-conductive metallic slice 33, the thermally-conductive structures 32 is also capable of directly removing a portion of heat energy away the LED heat dissipating module 3.

For increasing the intensity of the light beams, the output power of the LEDs should be increased to meet the user's requirement. As the output power of the LEDs is increased, more heat energy is generated from the LEDs. For further enhancing the heat dissipating efficiency, the LED heat dissipating module needs to be further improved.

FIG. 5 is a schematic front view illustrating a LED heat dissipating module according to a second embodiment of the present invention. The LED heat dissipating module 3 comprises a plurality of flat LEDs 30, a circuit board 31, a plurality of thermally-conductive structures 32, and a thermally-conductive metallic slice 33. The flat LEDs 30, the circuit board 31, the thermally-conductive structures 32 and the thermally-conductive metallic slice 33 included in the LED heat dissipating module 3 are identical to those shown in the first embodiment, and are not redundantly described herein. In addition, the LED heat dissipating module 3 of FIG. 5 further comprises a heat sink 34 beside the thermally-conductive metallic slice 33. The heat sink 34 is in contact with the thermally-conductive metallic slice 33 and the thermally-conductive structures 32 in order to increase the speed of dissipating the heat energy. It is preferred that the heat sink 34 is made of aluminum. The configurations of the heat sink 34 are known in the art, and are not redundantly described herein.

In the LED heat dissipating module of the present invention from the above description, the circuit board has a plurality of perforations, the thermally-conductive metallic slice having a plurality of openings is disposed on the backside of the circuit board, and the thermally-conductive structures are accommodated within the perforations for conducting heat energy to the thermally-conductive metallic slice, so that the heat energy is exhausted out of the LED heat dissipating module. According to the user's requirement, a heat sink is optionally arranged beside the thermally-conductive metallic slice in order to enhance the heat dissipating efficiency of the LED heat dissipating module. As previously described, the circuit board of the conventional LED heat dissipating module is an aluminum-based MCPCB, which is very costly. Since the circuit board of the LED heat dissipating module of the present invention is made of epoxy glass fiber sheet (FR4) material, the fabricating cost is largely reduced. Therefore, the LED heat dissipating module of the present invention could obviate the drawbacks of having high cost and low heat dissipating efficiency that are encountered in the prior art.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A LED heat dissipating module, comprising:
a circuit board having a plurality of perforations;
a plurality of light emitting diodes disposed on a surface of said circuit board and corresponding to respective perforations, wherein said perforations are covered by corresponding light emitting diodes;
a plurality of thermally-conductive structures connected with respective light emitting diodes and inserted into corresponding perforations for conducting heat energy that is generated from said light emitting diodes; and
a thermally-conductive metallic slice having a plurality openings corresponding to said perforations of said circuit board such that said thermally-conductive structures are permitted to be penetrated through corresponding openings, wherein said thermally-conductive metallic slice is disposed on a backside of said circuit board and in contact with said thermally-conductive structures for conducting said heat energy that is generated from said light emitting diodes and removing said heat energy.

2. The LED heat dissipating module according to claim 1 wherein said openings are aligned with said perforations of said circuit board such that said thermally-conductive structures are penetrated through corresponding perforations and corresponding openings.

3. The LED heat dissipating module according to claim 1 wherein said thermally-conductive metallic slice is a tin board or a gold-plated board.

4. The LED heat dissipating module according to claim 1 further comprising a heat sink, which is in contact with said thermally-conductive metallic slice and said thermally-conductive structures for facilitating dissipating said heat energy.

5. The LED heat dissipating module according to claim 4 wherein said heat sink is made of aluminum.

6. The LED heat dissipating module according to claim 1 wherein said circuit board is made of epoxy glass fiber sheet (FR4) material.

7. The LED heat dissipating module according to claim 1 wherein said light emitting diodes are surface mount device LEDs (SMD LEDs) that are mounted on said circuit board according to a surface mount technology (SMT).

8. The LED heat dissipating module according to claim 7 wherein each of said SMD LEDs is a 5050 SMD LED having a dimension of 5 mm×5 mm.

9. The LED heat dissipating module according to claim 1 wherein said thermally-conductive structures are thermal greases or thermal adhesives.
